(19) United States
(12) Patent Application Publication
(10) Pub. No.: US 2025/0162445 A1
(43) Pub. Date: May 22, 2025

(54) SUSTAINABLE COMMUNICATION SYSTEM

(71) Applicant: Shenzhen Yinwang Intelligent Technologies Co., Ltd., Shenzhen (CN)

(72) Inventors: David Lopez-Perez, Boulogne Billancourt (FR); Nicola Piovesan, Boulogne Billancourt (FR); Antonio De Domenico, Boulogne Billancourt (FR); Dzmitry Tsishkou, Boulogne Billancourt (FR); Hongqiang Bao, Shanghai (CN)

(73) Assignee: Shenzhen Yinwang Intelligent Technologies Co., Ltd., Shenzhen (CN)

(21) Appl. No.: 19/023,198

(22) Filed: Jan. 15, 2025

Related U.S. Application Data
(63) Continuation of application No. PCT/EP2022/084497, filed on Dec. 6, 2022.

(51) Int. Cl. B60L 53/66; B60L 53/53; B60L 53/62; H04W 88/08

(52) U.S. Cl. CPC B60L 53/66; B60L 53/53; B60L 53/62; H04W 88/08

(57) ABSTRACT

A communication system is provided, the communication system comprising a base station (BS) for providing connectivity to a plurality of user equipment (UEs) and a re-chargeable BS power source configured for supplying the BS with electric energy. The re-chargeable BS power source can be recharged by means of vehicle power sources of electric vehicles. The BS is configured for communicating with at least one UE of the plurality of UEs about at least one of charging the BS power source via a re-chargeable vehicle power source of an electric vehicle and charging the vehicle power source of the electric vehicle via the BS power source.

### CROSS-REFERENCE TO RELATED APPLICATIONS

This application is a continuation of International Application No. PCT/EP2022/084497, filed on Dec. 6, 2022, the disclosure of which is hereby incorporated by reference in its entirety.

### TECHNICAL FIELD

The present disclosure relates to a sustainable communication system comprising a base station powered by a re-chargeable power source.

### BACKGROUND

Communication networks, for example, cellular phone systems, comprise a plurality of (radio) base stations, BSs, or cell towers providing connectivity to user equipments, UEs, for example, cell phones. The BSs have to be supplied by electric energy for operation. The vast majority of BS sites has a convenient electric power grid connection. Wind and/or photovoltaic power generation and energy storage systems have been proposed for more rural and remote applications, particularly, those where an electric energy supply is not available or practical. Moreover, usage of clean, efficient and reliable renewable power sources is a key for sustainable mobile site operations in the context of efforts of cutting carbon emission. However, operation of wind and photovoltaic power sources heavily depends on weather conditions. This dependence causes a severe problem for continuous operation of BSs powered by such green energy sources.

### SUMMARY

In view of the above, the present application provides a sustainable communication system comprising a BS powered by a re-chargeable power source different from a commercial electric power grid that reliably allows for continuous operation of the BS.

According to a first aspect, it is provided a communication system comprising a base station (BS) for providing connectivity to a plurality of user equipments (UEs) and a re-chargeable BS power source configured for supplying the BS with electric energy. The BS is configured for communicating with at least one UE of the plurality of UEs about at least one of charging the BS power source by means of a re-chargeable vehicle power source of an electric vehicle and charging the vehicle power source of the electric vehicle by means of the BS power source.

The BS can be a radio BS of a wireless network, for example, a mobile cellular network or Wi-Fi network. The at least one UE may be any electronic device configured for communicating with the BS. For example, the at least one UE may be one of a cell phone, smart phone, Personal Digital Assistant, portable computer device etc. The electric vehicle may be any electrically powered moveable device and it may be equipped with the at least one UE, i.e., the at least one UE may be installed in the electric vehicle or it may be carried by a user of the electric vehicle. For example, the electric vehicle is an electric car, an electric Autonomous Guided vehicle, AGV, or an electric drone, etc.

The BS of the sustainable communication system according to the first aspect is powered by a re-chargeable BS power source (for example, a re-chargeable battery/battery pack) that can be re-charged by vehicle power sources of electric vehicles, i.e., supplied with green energy. Thus, the BS can be operated independently from weather conditions and without any connection to a commercial power grid. Additionally, the re-chargeable BS power source can be used for charging vehicle power sources of electric vehicles. The (operator of the) BS and the (user of the) at least one UE can communicate with each other, for example, negotiate, about the transaction of electric energy. Based on the communication (a driver of) the electric vehicle (as a user of the UE) may drive to the BS site for energy exchange. The communication may be performed partially or completely automatically in order to guarantee that sufficient electric power is continuously available at the BS site for operation of the BS.

According to an implementation, the communication system according to the first aspect further comprises a (stationary) charging station electrically connected to the BS power source and configured for at least one of the charging of the BS power source by means of the vehicle power source and the charging of the vehicle power source by means of the BS power source. The charging station may be further configured for at least one of charging the vehicle power source by means of another re-chargeable vehicle power source of another electric vehicle, charging the other vehicle power source of the other electric vehicle by means of the vehicle power source, charging the other vehicle power source of the other electric vehicle by means of the BS power source, and charging the BS power source by means of the other vehicle power source of the other electric vehicle.

The charging station allows for conveniently exchanging electric energy between the BS power source and vehicle power sources of electric vehicles. For example, a plurality of charging stations is provided for a plurality of parking spaces arranged at the BS site. Electric vehicles may drive to the parking spaces and provide electric energy via the charging stations or receive electric energy via the same.

According to another implementation, the communication system further comprises a mobile robot comprising a mobile robot power source and configured for autonomously navigating, for example, on a parking area designated to the BS. The mobile robot is further configured for at least one of charging the mobile robot power source by means of the vehicle power source and supplying electric energy either to the BS power source or another vehicle power source of another electric vehicle and charging the mobile robot power source by means of the BS power source and supplying electric energy to the vehicle power source or the other vehicle power source of the other electric vehicle. The mobile robot may be configured for communicating with at least one of the BS and the at least one UE.

The mobile robot power source may comprise a first mobile robot power source for powering the mobile robot and a second mobile robot power source reserved for storing electric energy that is to be supplied to the BS power source, the vehicle power source and/or the other vehicle power source. As compared to stationary charging stations, provision of the mobile robot may even further increase comfort and just-in-time efficiency of the charging procedure.

Reliable medium and/or large distance communication between the BS and the at least one UE is crucial for the long-term operation of the BS when relying on re-charging by means of vehicle power sources of electric vehicles. According to an implementation, the BS is configured for communicating with the at least one UE of the plurality of UEs by a wireless technology. For example, the BS is configured for communicating with the at least one UE of the plurality of UEs by a wireless technology using road site units, RSUs, passed by the electric vehicles. The wireless technology may be one of a cellular technology and a Wi-Fi technology.

The communication between the BS and the at least one UE includes information relevant for the energy transaction. According to an implementation, the BS is configured for communicating with the at least one UE of the plurality of UEs by transmitting to the at least one UE information on and least one of A) a charge status of the re-chargeable BS power source, B) an ability for and C) a willingness to at least one of to a) buy electric energy, b) get electric energy, c) sell electric energy and d) provide electric energy. Thereby, the at least one UE is informed about the energy/trading status of the BS and enabled to appropriately respond to the received information.

According to a suitable protocol, the (cellular) BS may be configured for transmitting the information in one of a) a Master Information Block, MIB, over a Physical Broadcast Channel, PBCH, and b) a System Information Block, SIB, over a Physical Data Shared Channel, PDSCH, for example, at periodic time intervals. In wireless communication systems, these channels are allocated and signalled in a standardized manner and they can conveniently be used for transmitting the information related to the energy transaction.

The UE may be configured for transmitting to the BS a response to the information transmitted by the BS and received by the UE, wherein the response comprises information on at least one of A) a charge status of the vehicle power source, B) an ability for and C) a willingness to at least one of to a) buy electric energy, b) get electric energy, c) sell electric energy and d) provide electric energy. All relevant information related to the energy transaction can be exchanged between the BS and the at least one UE. For example, the at least one UE is configured for transmitting the response periodically or a-periodically over a Physical Uplink Shared Channel, PUSCH, which is another channel allocated in a standardized manner. Alternatively, the BS configures the at least one UE through a new energy paging channel to transmit the response after reception of the information transmitted by the BS.

According to another implementation, the UE has not to wait for any information automatically transmitted from the BS but can initiate communication about the energy transaction. According to this implementation, the communication system further comprises the at least one UE that is configured for polling (asking) or checking the BS with respect to the at least one of a) charging the BS power source by means of a vehicle power source of an electric vehicle and b) charging the vehicle power source of the electric vehicle by means of the BS power source, for example, by means of an application running on the UE. The BS may respond to the polling and after exchange of the relevant information (a driver of) the electric vehicle may drive to the BS site for energy exchange. According to an alternative it is checked by the UE by means of an application running on the UE and a database, for example, comprising a map with BS sites, whether the BS (and/or any other BS) is willing/able to transact energy.

According to a second aspect, user equipment, UE, configured for communicating with a base station, BS, powered by a re-chargeable BS power source about at least one of charging the BS power source by means of a re-chargeable vehicle power source of an electric vehicle and charging the vehicle power source of the vehicle by means of the BS power source is provided. The UE may be one of a cell phone, smart phone, Personal Digital Assistant, portable computer device, etc.

The UE may be configured for communicating with the BS by a wireless technology, for example, a wireless technology using road site units, RSUs.

According to an implementation, the UE is configured for receiving information on at least one of A) a charge status of the re-chargeable BS power source, B) an ability for and C) a willingness to at least one of to a) buy electric energy, b) get electric energy, c) sell electric energy and d) provide electric energy.

The UE may be configured for receiving the information in one of a) a Master Information Block, MIB, over a Physical Broadcast Channel, PBCH, and b) a System Information Block, SIB, over a Physical Data Shared Channel, PDSCH, for example, at periodic time intervals.

According to another implementation, the UE is configured for transmitting a response to the information received from the BS, wherein the response comprises information on at least one of A) a charge status of the vehicle power source, B) an ability for and C) a willingness to at least one of to a) buy electric energy, b) get electric energy, c) sell electric energy and d) provide electric energy.

The UE may be configured for transmitting the response periodically or a-periodically over a Physical Uplink Shared Channel, PUSCH.

According to another implementation, the UE is configured for receiving the information upon polling the BS.

The UE according to the second aspect provides the same or similar advantages as the communication system according to the first aspect and implementations thereof.

According to a third aspect, a method of exchanging between a base station, BS, powered by a re-chargeable BS power source and a user equipment, UE, information on electric charging is provided. The method comprises the steps of transmitting from the BS to the UE information on and least one of A) a charge status of the re-chargeable BS power source, B) an ability for and C) a willingness to at least one of to a) buy electric energy, b) get electric energy, c) sell electric energy and d) provide electric energy and transmitting from the UE to the BS a response to the information received from the BS, wherein the response comprises information on at least one of A) a charge status of a re-chargeable vehicle power source of an electric vehicle, B) an ability for and C) a willingness to at least one of to a) buy electric energy, b) get electric energy, c) sell electric energy and d) provide electric energy.

The information may be transmitted by the BS in one of a) a Master Information Block, MIB, over a Physical Broadcast Channel, PBCH, and b) a System Information Block, SIB, over a Physical Data Shared Channel, PDSCH, for example, at periodic time intervals. The response may be transmitted by the UE periodically or a-periodically over a Physical Uplink Shared Channel, PUSCH.

According to an implementation, the information is transmitted by the BS by means of one of a wireless technology and a wireless technology using road site units, RSUs and the response is transmitted by the UE by means of the wireless technology.

According to a fourth aspect, it is provided a method of exchanging between a base station, BS, powered by a re-chargeable BS power source and a user equipment, UE, information on electric charging, comprising polling or checking the BS by the UE with respect to information on and least one of A) a charge status of the re-chargeable BS power source, B) an ability for and C) a willingness to at least one of to a) buy electric energy, b) get electric energy, c) sell electric energy and d) provide electric energy.

According to a fifth aspect, a method of transferring electric energy between a re-chargeable base station, BS, power source supplying a BS with electric energy and a re-chargeable vehicle power source of an electric vehicle equipped with a user equipment, UE is provided. The method comprises the steps of communicating between the BS and the UE information about at least one of charging the BS power source by means of the vehicle power source of the electric vehicle equipped with the UE and charging the vehicle power source of the electric vehicle equipped with the UE by means of the BS power source, driving the electric vehicle to the site of the BS and performing one of charging the BS power source by means of the vehicle power source of the electric vehicle equipped with the UE and charging the vehicle power source of the electric vehicle equipped with the UE by means of the BS power source based on the communicated information.

The method according to the third, fourth and fifth aspects as well as the implementations thereof provide the same or similar advantages as the above-described communication system according to the first aspect and implementations thereof and may at least partially be implemented in the above-described communication system according to the first aspect and implementations thereof and/or the UE according to the second aspect and implementations thereof. On the other hand, the communication system according to the first aspect and implementations thereof and the UE according to the second aspect and implementations thereof may be configured to perform the method according to one of the third, fourth and fifth aspects as well as the implementations thereof.

According to sixth aspect, it is provided a method of trading electric energy comprising concluding a contract between an operator or equipment vendor of a BS and an owner of an electric vehicle on buying and selling electric energy stored in a BS power source supplying the BS with electric energy and electric energy stored in a vehicle power source supplying the electric vehicle with electric energy. This method of trading electric energy, furthermore, comprises the steps of one of the above-described methods according to the third, fourth or fifth aspect or any implementation thereof. Results of negotiations on energy transactions costs can be comprised in the contract. and, thus, have not to be explicitly communicated between the BS and the UE (carried by the owner of the electric vehicle or installed in the electric vehicle, for example).

According to a seventh aspect, a computer program product comprising computer readable instructions for, when run on a computer, performing the steps of the method according to one of the third, fourth, fifth and sixth aspects as well as the implementations thereof is provided.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 illustrates a communication system comprising a BS and a re-chargeable BS power source according to an embodiment.

FIG. 2 illustrates a sport venue comprising a parking lot and a communication system according to an embodiment.

FIG. 3 illustrates an electric vehicle powered by a re-chargeable vehicle power source and equipped with an UE according to an embodiment.

FIG. 4 illustrates a method of exchanging information on electric charging between a BS powered by a re-chargeable BS power source and a UE according to an embodiment.

FIG. 5 illustrates a method of exchanging information on electric charging between a BS powered by a re-chargeable BS power source and a UE according to another embodiment.

FIG. 6 illustrates a method of exchanging electric energy between a re-chargeable BS power source supplying a BS with electric energy and a re-chargeable vehicle power source of an electric vehicle equipped with a UE according to an embodiment.

FIG. 7 illustrates a communication method according to an embodiment.

FIG. 8 illustrates a portion of a BCCH-BCH-Message including information on energy transactions that can be used in the method illustrated in FIG. 7.

### DETAILED DESCRIPTION OF THE EMBODIMENTS

Herein, it is provided a sustainable communication system comprising a BS providing connectivity to a plurality of UEs wherein the BS is powered by a re-chargeable BS power source. The re-chargeable BS power source can be re-charged by means of re-chargeable vehicle power sources installed in electric vehicles. On the other hand, the re-chargeable BS power source may be used for re-charging the re-chargeable vehicle power sources. Thus, green energy management for a system of one or more BSs and electric vehicles can be provided.

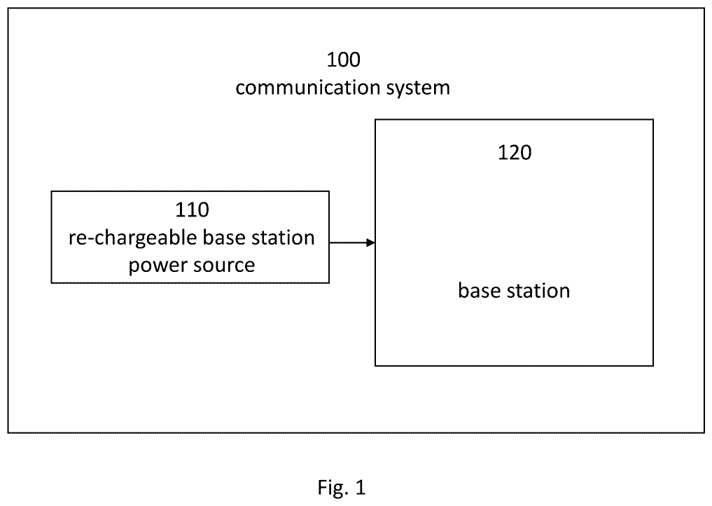

FIG. 1 illustrates an embodiment of a communication system 100 according to the present disclosure. The communication system 100 comprises a re-chargeable base station, BS, power source (for example, a re-chargeable battery) for supplying the BS 120 with electric energy. The BS 120 provides connectivity to a plurality of user equipments, UE. The communication system 100 may comprise more than one BS 120. For example, the BS 120 is a cellular BS providing connectivity to cell phones or the BS 120 is a WiFi access point (AP) for providing connectivity to WIFI devices. According to an embodiment, the BS 120 is a cellular 5G 3GPP new radio (NR) BS.

The BS 120 is configured for communicating (for example, negotiating) with at least one UE of the plurality of UEs about at least one of a) charging the BS power source 110 by means of a re-chargeable vehicle power source of an electric vehicle (for example, equipped with the at least one UE) and b) charging the re-chargeable vehicle power source of the electric vehicle (for example, equipped with the at least one UE) by means of the BS power source 110. Electric energy can be transferred between the BS power source 110 and the vehicle power source. The electric vehicle can be any moveable electric device. For example, the electric vehicle is an electric car, an electric Autonomous Guided Vehicle, or electric drone. The UE may be installed in the electric vehicle or removable positioned in the electric vehicle, for example, carried by a user of the electric vehicle.

In particular, (an operator of) the BS 120 can transmit to the (user of the) UE information on a charge status of the re-chargeable BS power source 110, an ability for and/or a willingness to buy electric energy, get electric energy, sell electric energy and/or provide electric energy. The UE receives this information and appropriately reacts on that, for example, by responding to the received information. Based on the communication between the BS 120a and the UE (a driver of) the electric vehicle may drive to the BS site for exchanging electric energy between the vehicle power source and the BS power source 110.

The BS and the UE may communicate with each other via wireless technology, for example, wireless cell or Wi-Fi technology. The UE may at least partially receive this information via roadside units (RSUs). For example, the RSUs convey said information through a new field of a NR C-V2X sidelink operating either in broadcasting or reliable multicast.

Alternatively, the UE polls or checks the BS 120 with respect to the ability for and/or a willingness to buy electric energy, get electric energy, sell electric energy and/or provide electric energy and (a driver of) the electric vehicle may appropriately react on the response received from the BS 120, for example, by driving to the BS site for exchanging electric energy with the BS power source 110.

The vehicle power source and the BS power source 110 may transfer electric energy from one to the other by means of a stationary charging station electrically connected to the BS power station 110. Alternatively or additionally, a mobile robot may be provided for the energy exchange.

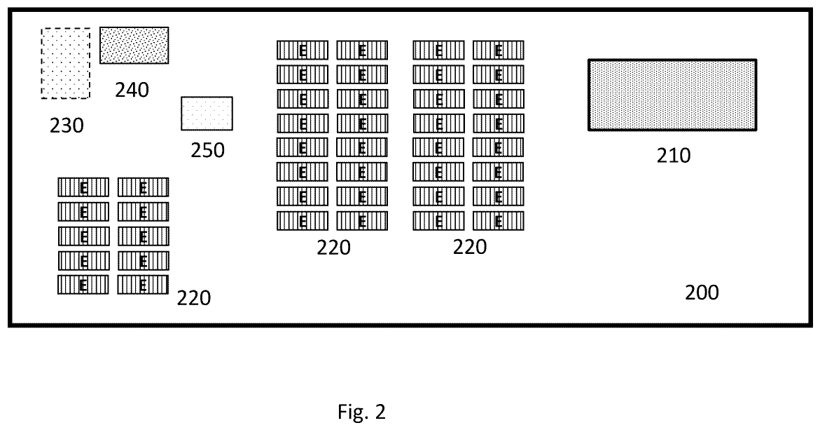

FIG. 2 illustrates a major sport venue 200 comprising a stadium 210, for example, a football stadium. The sport venue comprises a parking lot comprising many parking spaces 220 for vehicles, in particular, electric vehicles. Furthermore, a BS site is located in the sport venue 200 the BS site comprising a communication system comprising a BS 230 and a re-chargeable BS power source 240. Further, the BS site comprises a mobile robot 250 comprising a mobile robot power source and configured for autonomously navigating on the parking lot and BS site. The mobile robot 250 may comprise a charging connecting for exchanging electric energy with the BS 230 and an electric vehicle or a charging station of a parking space 220.

Consider a scenario in that one of the electric vehicles is equipped with an UE communicating with the BS 230 about charging the BS power source 240 by means of a vehicle power source of the electric vehicle and/or charging the vehicle power source of the vehicle by means of the BS power source 240. Say that (the operator of) the BS 230 is able and willing to get/buy electric energy. In this case, the mobile robot 250 approaches the vehicle and performs a charging operation of the mobile robot power source. After completion of the charging operation, the mobile robot 250 moves to the BS power source 240 for charging the same with the electric energy previously received from the vehicle power source. Say that (the operator of) the BS 230 is able and willing to provide/sell electric energy. In this case, the mobile robot 250 approaches the vehicle and performs a charging operation for supplying the vehicle power source with electric energy previously received from the BS power source 240.

It is noted that the mobile robot 250 may also be used for exchanging electric energy between a vehicle power source of one electric vehicle equipped with an UE and parking on a parking space 220 of the parking lot and another vehicle power source of another electric vehicle equipped with another UE and parking on another parking space 220 of the parking lot.

According to an alternative embodiment, the mobile robot 250 is replaced or supplemented by stationary charging stations provided at the parking spaces.

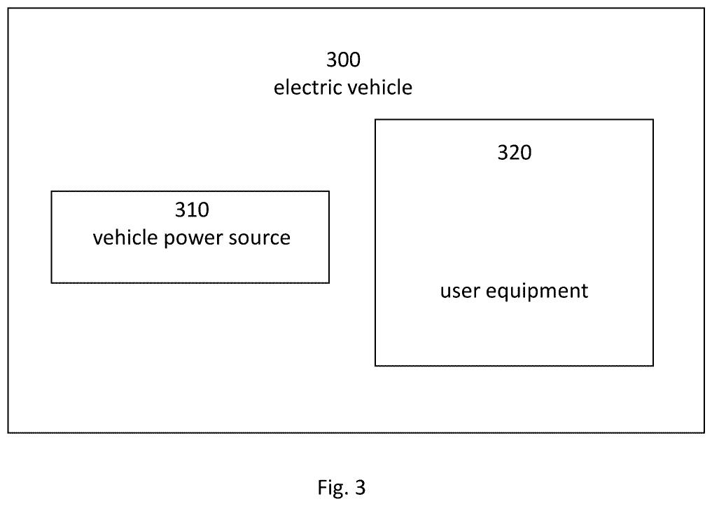

FIG. 3 illustrates an electric vehicle 300 powered by a re-chargeable vehicle power source 310 and equipped with an UE 320 according to an embodiment. The UE 320 according to the embodiment is configured for communicating with a base station, BS, powered by a re-chargeable BS power source, for example, the BS 120 shown in FIG. 1 or the BS 230 shown in FIG. 3, about charging the BS power source by means of the vehicle power source 310 of the vehicle 300 equipped with the UE 320 and/or charging the vehicle power source 310 of the vehicle 300 equipped with the UE 320 by means of the BS power source. The UE may be comprised by the communication system 100 shown in FIG. 1.

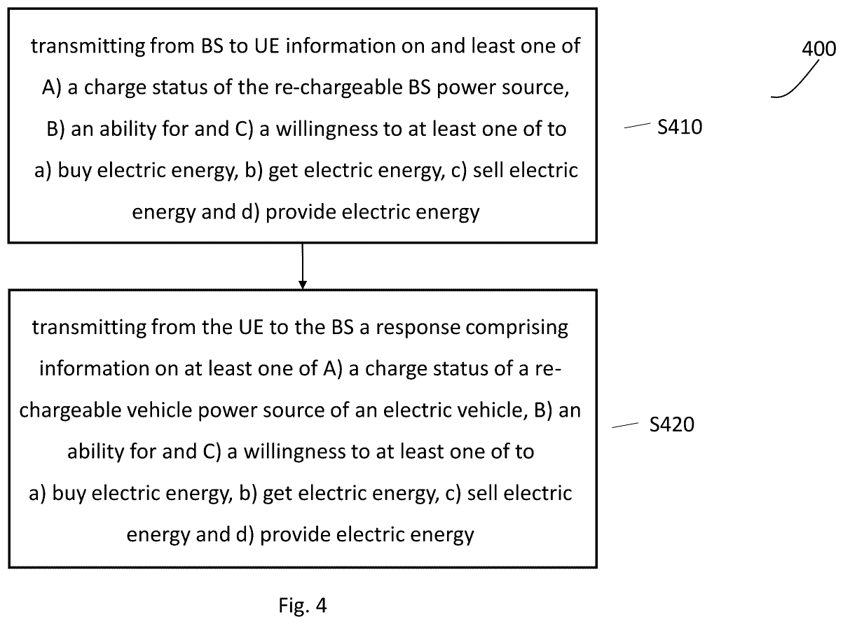

FIG. 4 illustrates a method 400 of exchanging information on electric charging between a BS powered by a re-chargeable BS power source and a UE according to an embodiment. The method 400 comprises transmitting S410 from the BS to the UE information on and least one of A) a charge status of the re-chargeable BS power source, B) an ability for and C) a willingness to at least one of to a) buy electric energy, b) get electric energy, c) sell electric energy and d) provide electric energy. The BS may transmit the information in a new dedicated field in a Master Information Block (MBI) in a Physical Broadcast Channel (PBCH). Alternatively, the BS may transmit the information in a new dedicated field in another system information block carried over a Physical Data Shared Channel (PDSCH), for example, within periodically occurring time-domain windows.

In response to the reception of the information transmitted S410 by the BS the UE transmits S420 a response to the BS comprising information on at least one of A) a charge status of a re-chargeable vehicle power source of an electric vehicle, B) an ability for and C) a willingness to at least one of to a) buy electric energy, b) get electric energy, c) sell electric energy and d) provide electric energy. According to this embodiment, communication between the BS and UE is initiated by the BS and allows for the management of electric energy transfer between the re-chargeable BS power source and the re-chargeable vehicle power source in the one or the other direction.

A network operator may configure, for example, through a new Radio Resource Control (RRC) configuration, UEs to respond with information on the vehicle power source charging levels, for example, on a regular basis, over a (semi-persistent allocated) Physical Uplink Shared Channel (PUSH). Alternatively, the UEs may be configured by the BS over a new energy paging channel to respond to the information transmitted by the BS. According to another embodiment, UEs respond to BS broadcasts a-periodically using a dedicated response message transmitted over the PUSCH.

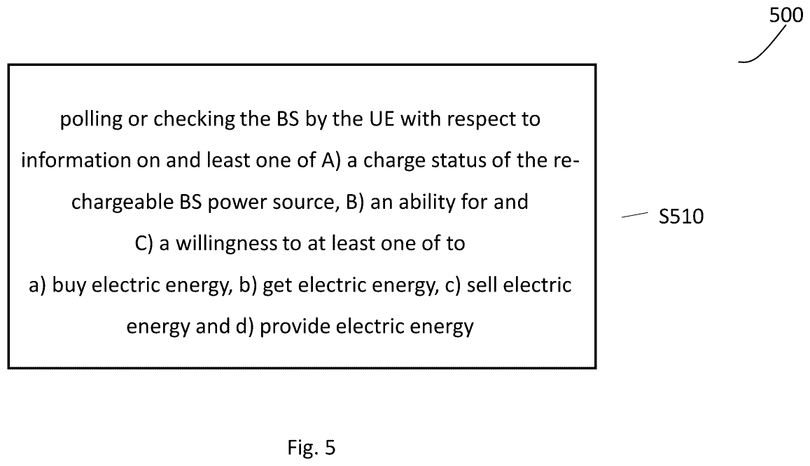

FIG. 5 illustrates a method 500 of exchanging information on electric charging between a BS powered by a re-chargeable BS power source and a UE according to another embodiment. The method 500 comprises polling (asking) S510 the BS by the UE with respect to information on and least one of A) a charge status of the re-chargeable BS power source, B) an ability for and C) a willingness to at least one of to a) buy electric energy, b) get electric energy, c) sell electric energy and d) provide electric energy. According to this embodiment, communication between the BS and UE is initiated by the UE and the BS responds to the polling to allow for the management of electric energy transfer between the re-chargeable BS power source and the re-chargeable vehicle power source in the one or the other direction.

Alternatively, the method 500 comprises checking the BS by the UE with respect to information on and least one of A) a charge status of the re-chargeable BS power source, B) an ability for and C) a willingness to at least one of to a) buy electric energy, b) get electric energy, c) sell electric energy and d) provide electric energy. According to this alternative embodiment, the UE can check, for example, based on an application running on the UE and a database comprising a map including the positions of a number of BSs, whether the BS is willing to trade energy. If the outcome of the checking process is positive, the energy transaction process can be initiated and carried out.

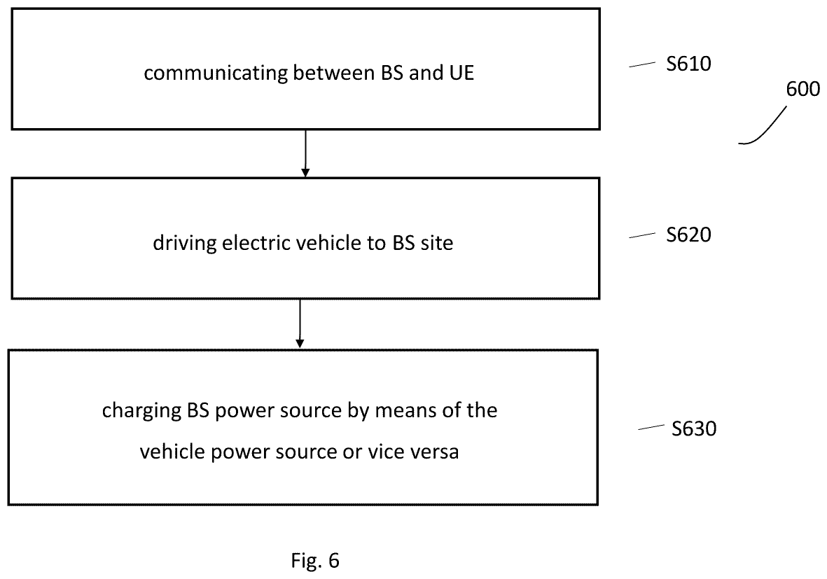

FIG. 6 illustrates a method 600 of transferring electric energy between a re-chargeable BS power source supplying a BS with electric energy and a re-chargeable vehicle power source of an electric vehicle equipped with a UE according to an embodiment. The method comprises communicating S610 between the BS and the UE information about at least one of charging the BS power source by means of the vehicle power source of the electric vehicle equipped with the UE and charging the vehicle power source of the electric vehicle equipped with the UE by means of the BS power source.

Based on the (outcome of the) communication (a driver of) the electric vehicle drives S620 to the site of the BS. After the vehicle has arrived at the BS site and based on the communicated information either charging S620 the BS power source by means of the vehicle power source of the electric vehicle equipped with the UE or charging S620 the vehicle power source of the electric vehicle equipped with the UE by means of the BS power source is performed.

Each of the methods 400, 500 and 600 illustrated in FIGS. 4, 5, and 6, respectively, can at least partially be implemented in the BS 120 of the communication system 100 shown in FIG. 1, the base station 230 shown in FIG. 2 or the UE 320 shown in FIG. 3 and these entities can be configured to at least partially perform at least one of the methods 400, 500 and 600.

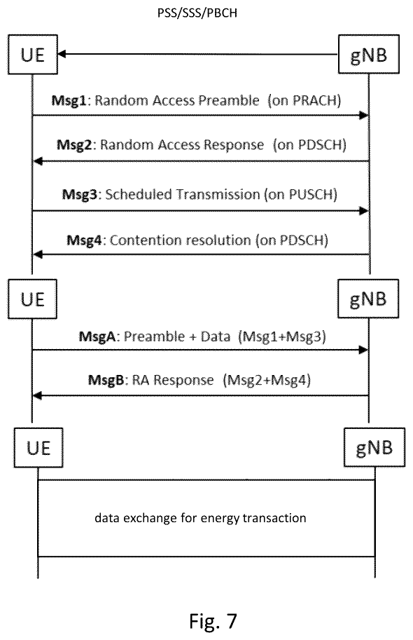

FIG. 7 illustrates a communication method according to an embodiment. A BS and a UE communicate with each other. In the embodiment shown in FIG. 7 communication in the context of 5G is illustrated wherein the BS is a gNodeB (gNB) using New Radio (NR) technology. However, the procedure shown in FIG. 7 is not restricted to 5G but may also be applied to other radio/cellular technologies. The gNB transmits in a synchronization signal block (SSB) primary and secondary synch signals PSS and SSS and an established/allocated Physical Broadcast Channel PBCH including an enhanced (as compared to the present standard) Master Information Block (MIB). By detection of the signals and the channel the UE can synchronize with the gNB during an initial network entry phase.

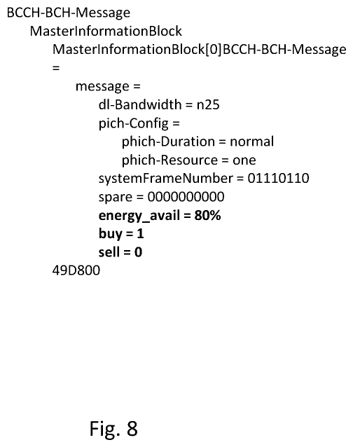

An example for a suitably enhanced MIB being a portion of a BCCH-BCH-Message transmitted over the PBCH and including information on possible electric energy transactions that can be used in the method illustrated in FIG. 7, for example, is shown in FIG. 8. The information on possible electric energy transactions is represented by 3 new fields (see entries in boldface in FIG. 8), namely, the BS electric energy availability (80% in the example shown in FIG. 8), and the willingness of the BS (gNB) to buy electric energy (=TRUE in the example shown in FIG. 8) and sell electric energy (=FALSE in the example shown in FIG. 8), respectively.

The UE can respond over a Physical Uplink Shared Channel (PUSCH) to the information on possible electric energy transactions transmitted by the gNB according to the 3GPPP Release 16 two step-RACH (2SR) protocol (see Msg1 to Msg4 of FIG. 7). MsgA in FIG. 7 represents a response (ACK) message sent by the UE and indicating in the data part of the message willingness of the UE to buy from the gNB electric energy or sell to the gNB electric energy.

After having received the response message from the UE the gNB provides a protocol for exchanging data related to the energy transaction. The data can be exchanged by messages transmitted over the Physical Data Shared Channel (PDSCH) and PUSH. The protocol for exchanging data related to the energy transaction may include information on the location of the gNB and the UE, location and time of energy transaction as well as any agreement on transaction costs. The location of energy transaction may be a parking space 220 shown in FIG. 2, for example. The gNB or the UE may provide the mobile robot 250 shown in FIG. 2 with the information of the location of energy transaction. The gNB or the UE may instruct the mobile robot to perform the energy transaction or the mobile robot performs the energy transaction automatically as soon as the UE (vehicle equipped with the UE) arrived at the designated location (parking space 220, for example).

The method illustrated in FIG. 7 may be comprised by the method 400 illustrated in FIG. 4 or the method 600 illustrated in FIG. 6.

All previously discussed embodiments are not intended as limitations but serve as examples illustrating features and advantages of the invention. It is to be understood that some or all of the above-described features can also be combined in different ways.

What is claimed is:

1. A communication system, comprising:
a base station (BS) for providing connectivity to a plurality of user equipment (UEs); and
a rechargeable BS power source configured for supplying the BS with electric energy,
wherein the BS is configured to communicate with at least one UE of the plurality of UEs regarding at least one of:
charging the rechargeable BS power source via a rechargeable vehicle power source of an electric vehicle, and/or
charging the vehicle power source of the electric vehicle via the rechargeable BS power source.

2. The communication system according to claim 1, further comprising:
a charging station electrically connected to the rechargeable BS power source and configured to perform at least one of the charging the rechargeable BS power source via the vehicle power source and/or the charging the vehicle power source via the rechargeable BS power source.

3. The communication system according to claim 2, wherein the charging station is further configured to perform at least one of:
charging the vehicle power source via another re-chargeable vehicle power source of another electric vehicle,
charging the other vehicle power source of the other electric vehicle via the vehicle power source,
charging the other vehicle power source of the other electric vehicle via the rechargeable BS power source, and/or
charging the rechargeable BS power source via the other vehicle power source of the other electric vehicle.

4. The communication system according to claim 1, further comprising a mobile robot comprising a mobile robot power source and configured to autonomously navigate on a parking area designated to the BS and configured to perform at least one of:
charging the mobile robot power source via the vehicle power source and supplying electric energy either to the rechargeable BS power source or to another vehicle power source of another electric vehicle, and/or
charging the mobile robot power source via the rechargeable BS power source and supplying electric energy to the vehicle power source or the other vehicle power source of the other electric vehicle.

5. The communication system according to claim 1, wherein the BS is configured to communicate with the at least one UE of the plurality of UEs via a wireless technology.

6. The communication system according to claim 5, wherein the wireless technology is a cellular technology or a Wi-Fi technology.

7. The communication system according to claim 1, wherein the electric vehicle is equipped with the at least one UE of the plurality of UEs.

8. The communication system according to claim 1, wherein the BS is configured to communicate with the at least one UE of the plurality of UEs by transmitting, to the at least one UE, information on at least one of: a charge status of the rechargeable BS power source, and an ability for and/or a willingness to at least one of buy electric energy, get electric energy, sell electric energy, and/or provide electric energy.

9. The communication system according to claim 8, wherein the BS is configured to transmit the information in one of a Master Information Block (MIB) over a Physical Broadcast Channel (PBCH) and a System Information Block (SIB) over a Physical Data Shared Channel (PDSCH).

10. The communication system according to claim 8, further comprising the at least one UE that is configured to transmit a response to the information transmitted by the BS, wherein the response comprises information on at least one of a charge status of the vehicle power source and an ability for and/or a willingness to at least one of buy electric energy, get electric energy, sell electric energy, and/or provide electric energy.

11. The communication system according to claim 10, wherein the at least one UE is configured for transmitting the response periodically or a-periodically over a Physical Uplink Shared Channel (PUSCH).

12. The communication system according to claim 8, further comprising the at least one UE that is configured for polling or checking the BS with respect to the at least one of charging the BS power source via the vehicle power source of the electric vehicle and charging the vehicle power source of the electric vehicle via the BS power source.

13. A user equipment (UE) comprising:
a processor; and
a transceiver,
wherein the UE is configured to communicate with a base station (BS) powered by a rechargeable BS power source about at least one of:
charging the BS power source via a re-chargeable vehicle power source of an electric vehicle; and
charging the vehicle power source of the vehicle via the BS power source.

14. The UE according to claim 13, wherein the UE is configured to communicate with the BS via a wireless technology.

15. The UE according to claim 13, wherein the UE is configured to receive information on at least one of a charge status of the re-chargeable BS power source, an ability for and/or a willingness to at least one of buy electric energy, get electric energy, sell electric energy, and/or provide electric energy.

16. The UE according to claim 15, wherein the UE is configured to receive the information in one of a Master Information Block (MIB) over a Physical Broadcast Channel (PBCH) and/or a System Information Block (SIB) over a Physical Data Shared Channel (PDSCH).

17. The UE according to claim 15, wherein the UE is configured to transmit a response to the information received from the BS, wherein the response comprises information on at least one of a charge status of the vehicle power source and an ability for and/or a willingness to at least one of buy electric energy, get electric energy, sell electric energy, and/or provide electric energy.

18. The UE according to claim 17, wherein the UE is configured to transmit the response periodically or a-periodically over a Physical Uplink Shared Channel (PUSCH).

19. The UE according to claim 15, wherein the UE is configured to receive the information upon polling the BS.

20. A method of exchanging, between a base station (BS) powered by a rechargeable BS power source and a user equipment (UE), information on electric charging, the method comprising:
transmitting, from the BS to the UE, information on at least one of a charge status of the re-chargeable BS power source and an ability for and/or a willingness to at least one of buy electric energy, get electric energy, sell electric energy, and provide electric energy; and
transmitting from the UE to the BS a response to the information received from the BS, wherein the response comprises information on at least one of a charge status of a re-chargeable vehicle power source of an electric vehicle and an ability for and/or a willingness to at least one of buy electric energy, get electric energy, sell electric energy, and/or provide electric energy.

21. The method according to claim 20, wherein the information is transmitted by the BS in one of a Master Information Block (MIB) over a Physical Broadcast Channel (PBCH) and a System Information Block (SIB) over a Physical Data Shared Channel (PDSCH).

22. The method according to claim 20, wherein the response is transmitted by the UE periodically or a-periodically over a Physical Uplink Shared Channel (PUSCH).

23. The method according to claim 20, wherein the information is transmitted by the BS via a wireless technology, and wherein the response is transmitted by the UE via the wireless technology.

24. A method of exchanging, between a base station (BS) powered by a rechargeable BS power source and a user equipment (UE), information on electric charging, the method comprising:
polling or checking the BS by the UE with respect to information on at least one of a charge status of the re-chargeable BS power source and an ability for and/or a willingness to at least one of buy electric energy, get electric energy, sell electric energy, and provide electric energy.

25. A method of transferring electric energy between a re-chargeable base station (BS) power source supplying a BS with electric energy and a rechargeable vehicle power source of an electric vehicle equipped with a user equipment (UE), the method comprising:
communicating between the BS and the UE information about at least one of:
charging the BS power source via the vehicle power source of the electric vehicle equipped with the UE, and/or
charging the vehicle power source of the electric vehicle equipped with the UE via the BS power source;
driving the electric vehicle to the site of the BS; and
performing one of:
charging the BS power source via the vehicle power source of the electric vehicle equipped with the UE; and
charging the vehicle power source of the electric vehicle equipped with the UE via the BS power source based on the communicated information.

26. A computer program product comprising computer readable instructions that, when executed by a computer, cause the computer to perform the steps of the method according to claim 20.
